(19) United States
(12) Patent Application Publication
(10) Pub. No.: US 2019/0173124 A1
(43) Pub. Date: Jun. 6, 2019

(54) ELECTROLYTE AND LITHIUM-ION BATTERY

(71) Applicant: Ningde Amperex Technology Limited, Ningde (CN)

(72) Inventors: Shuirong Zhang, Ningde (CN); Junfei Liu, Ningde (CN); Chao Tang, Ningde (CN); Juan Ma, Ningde (CN); Qunfeng Wang, Ningde (CN)

(21) Appl. No.: 16/167,869

(22) Filed: Oct. 23, 2018

(30) Foreign Application Priority Data
Dec. 6, 2017 (CN) 201711279757.9

(51) Int. Cl. H01M 10/0525; H01M 10/04; H01M 10/0567

(52) U.S. Cl. CPC H01M 10/0525; H01M 10/0567; H01M 10/0459; H01M 10/045

(57) ABSTRACT

Examples of the present application provide an electrolyte comprising a lithium salt, an organic solvent, and an additive, wherein the additive comprises a nitrile compound, a fluorophosphazene, and a fluoroether. By using the electrolyte comprising a nitrile compound, a fluorophosphazene, a fluoroether, the thermal stability of the electrolyte itself and the positive electrode material may be significantly improved through the synergistic effect of above three and the safety of the lithium-ion battery is greatly enhanced when the electrolyte is applied to the lithium-ion battery. In addition, by adding a cyclic carbonate with carbon-carbon double bond and fluorocyclic carbonate and by controlling the mass percentage of nitrile compound, fluorophosphazene, fluoroether in electrolyte, significant improvements in the safety of lithium-ion batteries may be achieved without significantly degrading the cycling performance of the lithium-ion battery.

### CROSS-REFERENCE TO RELATED APPLICATION

This application claims priority to and benefits of Chinese Patent Application Serial No. 201711279757.9, filed with the State Intellectual Property Office of P. R. China on Dec. 6, 2017, and the entire content of which is incorporated herein by reference.

### FIELD OF THE APPLICATION

The examples of the present application relate to the field of battery, in particular, to an electrolyte and a lithium-ion battery.

### BACKGROUND OF THE APPLICATION

Today's lithium-ion batteries have been widely used in electric vehicles, smart phones, small drones and other fields. As the applications become more widespread, people are paying more and more attention to the safety of lithium-ion batteries. In particular, in recent years, incidents of lithium-ion batteries burning and exploding have been exposed. Therefore, the development of high-safety lithium-ion batteries is becoming a top priority for major battery manufacturers.

### SUMMARY OF THE APPLICATION

In order to overcome the above technical problems existing in the prior art, some examples of the present application provide an electrolyte comprising an additive, wherein the additive comprises a nitrile compound, a fluorophosphazene, and a fluoroether.

In above electrolyte, the nitrile compound is at least one selected from a group of compounds represented by formula 1, formula 2, and formula 3:

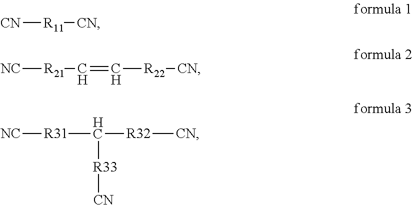

wherein R₁₁ is one selected from a group of alkylene comprising 1 to 5 carbon atoms and alkyleneoxy comprising 1 to 5 carbon atoms; R₂₁ and R₂₂ are each independently selected from one of alkylene comprising 0 to 5 carbon atoms; R₃₁, R₃₂ and R₃₃ are one each independently selected from a group of alkylene comprising 0 to 5 carbon atoms and alkyleneoxy comprising 1 to 5 carbon atoms.

The fluorophosphazene is one or more selected from a group of the compounds represented by formula 4 below:

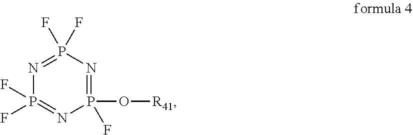

wherein R₄₁ is one selected from a group of alkyl comprising 1 to 6 carbon atoms, phenyl, halogenated alkyl, and halogenated phenyl;

The fluoroether is one or more selected from a group of the compounds represented by formula 5 below:

R₅₁—O—R₅₂ formula 5,

wherein R₅₁ and R₅₂ are each independently selected from one of fluoroalkyl comprising 1 to 5 carbon atoms.

In above electrolyte, the nitrile compound is at least one selected from a group of the following compounds:

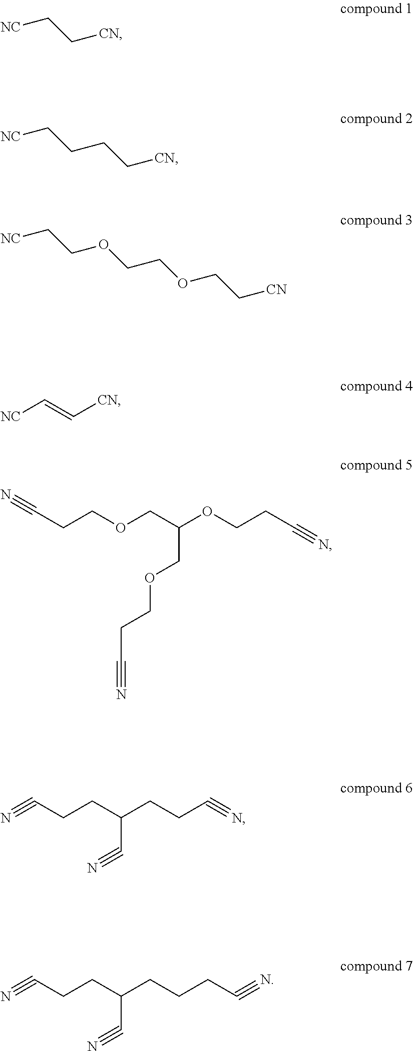

In above electrolyte, the fluorophosphazene is one or more selected from a group of 2,2,4,4,6-Pentafluoro-6-methoxy-2λ⁵,4λ⁵,6λ⁵-[1,3,5,2,4,6]triazatriph osphinine (CH₃OP₃N₃F₅), 2-Ethoxy-2,4,4,6,6-pentafluoro-2λ⁵,4λ⁵,6λ⁵-[1,3,5,2,4,6]triazatripho sphinin (C₂H₅OP₃N₃F₅), 2,2,4,4,6-Pentafluoro-6-propoxy-2λ⁵,4λ⁵,6λ⁵-[1,3,5,2,4,6]triazatriph osphinine (C₃H₇OP₃N₃F₅), 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), 2,2,4,4,6-Pentafluoro-6-phenoxy-2λ⁵,4λ⁵,6λ⁵-[1,3,5,2,4,6]triazatriph osphinine (C₆H₅OP₃N₃F₅), 2,2,4,4,6-Pentafluoro-6-(4-fluoro-phenoxy)-2λ⁵,4λ⁵,6λ⁵-[1,3,5,2,4,6]triazatriphosphinine (C₆H₄OP₃N₃F₆).

In above electrolyte, the fluoroether is one or more selected from a group of tetrafluoroethyl trifluoroethyl ether (CF₂HCF₂OCH₂CF3), tetrafluoroethyl tetrafluoropropyl ether (CF₂HCF₂OCH₂CF₂CF₂H), tetrafluoroethyl hexafluorobutyl ether (CF₂HCF₂OCH₂CF₂CF₂CF₂H), tetrafluoroethyl octafluoropentyl ether (CF₂HCF₂OCH₂CF₂CF₂CF₂CF₂H).

In above electrolyte, the mass percentage of the nitrile compound is 0.5% to 15% based on the total mass of the electrolyte, the mass percentage of the fluorophosphazene is 1% to 20% based on the total mass of the electrolyte, and the mass percentage of the fluoroether is 2% to 20% based on the total mass of the electrolyte.

In above electrolyte, the additive further comprises one or more selected from a group of cyclic carbonate with carbon-carbon double bond and fluorinated cyclic carbonate; the mass percentage of the cyclic carbonate with carbon-carbon double bond is 0.1% to 10% and the mass percentage of the fluorinated cyclic carbonate is 0.1% to 20% based on the total mass of the electrolyte.

In above electrolyte, the cyclic carbonate with carbon-carbon double bond is one or more selected from a group of vinylene carbonate (VC), 4-methylvinylene carbonate, and 4-ethylvinylene carbonate, and the fluorinated cyclic carbonate is one or more selected from a group of fluoroethylene carbonate (FEC), difluoroethylene carbonate, trifluoromethyl ethylene carbonate.

In above electrolyte, the electrolyte further comprises an organic solvent, and the organic solvent comprises one or more selected from a group of vinyl carbonate, propylene carbonate, butylene carbonate, ethyl methyl carbonate, dimethyl carbonate, diethyl carbonate, dipropyl carbonate, methyl propyl carbonate, ethyl propyl carbonate, 1,4-butyrolactone, methyl propionate, methyl butyrate, ethyl acetate, ethyl propionate, ethyl butyrate. In above electrolyte, the electrolyte further comprises a lithium salt, and the lithium salt is one or more selected from a group of lithium hexafluorophosphate (LiPF₆), lithium difluorophosphate (LiPO₂F₂), lithium tetrafluoroborate (LiBF₄), lithium hexafluoroarsenate, lithium perchlorate, lithium dioxalate borate (LiBOB), lithium difluoro(oxalato) borate (LiDFOB), lithium bis(fluorosulfonyl)imide (LiFSI), bistrifluoromethanesulfonimide lithium salt (LiTFSI), wherein the concentration of the lithium salt is 0.5 mol/L to 1.5 mol/L.

In above electrolyte, the lithium salt is lithium hexafluorophosphate (LiPF₆), and the concentration of the lithium salt is 0.8 mol/L to 1.2 mol/L.

According to some examples of the present invention, a lithium-ion battery comprising the above electrolyte is further provided.

In above lithium-ion battery, the lithium-ion battery further comprises a positive electrode containing a positive electrode active material, a negative electrode containing a negative electrode active material and a separator.

In above lithium-ion battery, the positive electrode active material is one or more selected from a group of lithium cobalt oxide (LiCoO₂), lithium nickel manganese cobalt ternary material, lithium iron phosphate (LiFePO₄), and lithium manganate (LiMn₂O₄), and the negative electrode active material is one or more selected from a group of natural graphite, artificial graphite, mesophase micro carbon sphere, hard carbon, soft carbon, silicon, silicon-carbon composites, Li—Sn alloy, Li—Sn—O alloy, Sn, SnO, SnO₂, lithium TiO₂—Li₄Ti₅O₁₂ with spinel structure, Li—Al alloy.

The inventor of the present application finds that the energy level of lone pair electrons in the nitrile functional group is close to the energy level of the outermost vacant orbit of the transition metal atom in the positive electrode active material of the lithium-ion battery, so that the nitrile compound containing cyano functional group may be subjected to complex adsorption on the surface of the positive electrode. Thus, the structural stability of the positive electrode surface of the lithium-ion battery in a charged state is enhanced, thereby improving its thermal stability. As the number of cyano functional groups in the nitrile compound increases, the adsorption effect may become more remarkable. The fluorophosphazene may capture the free radicals in the chain reaction during thermal runaway to delay the thermal runaway. The fluoroether has a high flash point or is non-flammable so as to increase the flash point of the electrolyte and reduce flammability thereof. Therefore, according to some examples of the present application, by using the electrolyte of the present application comprising a nitrile compound, a fluorophosphazene, a fluoroether, the thermal stability of the electrolyte itself and the positive electrode material may be significantly improved through the synergistic effect of above three and the safety of the lithium-ion battery is greatly enhanced when the electrolyte is applied to the lithium-ion battery. In addition, by adding cyclic carbonate with carbon-carbon double bond, fluorocyclic carbonate, and by adding the nitrile compound, fluorophosphazene, fluoroether in electrolyte and controlling the mass percentage of nitrile compound, fluorophosphazene and fluoroether, significant improvements in the safety of lithium-ion batteries may be achieved without significantly degrading the cycling performance of the lithium-ion battery.

### DETAILED DESCRIPTION OF THE PREFERRED EXAMPLES

The technical solutions in the examples of the present application will be clearly and completely described hereafter. It is apparent that the described examples are only a part of the examples of the present application, but not the whole. Based on the examples of the present application, all the other examples obtained by those of ordinary skill in the art are within the scope of the present application.

The electrolyte of lithium-ion battery contains a large amount of combustible organic solvent with low flash point, which may be ignited when a certain temperature and atmosphere condition is reached, thereby causing the lithium-ion battery to ignite or even explode. Improving the safety of the electrolyte may greatly improve the safety of the lithium-ion battery. At the same time, the thermal stability of the positive electrode materials in the lithium-ion battery at high voltage also profoundly affects the safe behavior of lithium-ion batteries. Commonly used positive electrode materials for lithium-ion batteries, especially lithium cobalt oxide materials, can undergo crystal transformation when being heated in delithiation state and will release oxygen simultaneously, so that the risk of ignition of lithium-ion batteries is greatly increased. Therefore, improving the thermal stability of the positive electrode material may also have an effect of improving the safety of the lithium-ion battery.

The inventor of the present application finds that the phosphorus-based additive may capture the free radicals in the chain reaction during thermal runaway to delay the thermal runaway, and the halogen-based additive with a higher flash point or being non-flammable can improve the flash point of the electrolyte. Both types of additives may improve the safety of lithium-ion batteries to some extent. The energy level of lone pair electrons in the nitrile functional group is close to the energy level of the outermost vacant orbit of the transition metal atom in the positive electrode active material of the lithium-ion battery, so that the nitrile compound containing cyano functional group may be subjected to complex adsorption on the surface of the positive electrode. Thus, the structural stability of the positive electrode surface of the lithium-ion battery in a charged state is enhanced, thereby improving its thermal stability. As the number of cyano functional groups in the nitrile compound increases, the adsorption effect may become more remarkable.

Based on the above findings, in some examples of the present application, a nitrile compound, a fluorophosphazene, and a fluoroether are applied in an electrolyte together. By adding the fluorophosphazene in the electrolyte, the free radicals in the chain reaction during the thermal runaway process may be captured, and the number of radicals and the intensity of the chain reaction may be reduced, thereby delaying the thermal runaway; at the same time, adding fluoroether with a higher flash point or of being non-flammable in a non-aqueous electrolyte may greatly increase the flash point of the electrolyte, thus the flammability of the electrolyte may be reduced; and the energy level of lone pair electrons in the nitrile functional group is close to the energy level of the outermost vacant orbit of the transition metal atom in the positive electrode active material of the lithium-ion battery, so that the nitrile compound containing cyano functional group may be subjected to complex adsorption on the surface of the positive electrode; thus, the structural stability of the positive electrode surface of the lithium-ion battery in a charged state is enhanced, thereby improving its thermal stability. As the number of cyano functional groups in the nitrile compound increases, the adsorption effect may become more remarkable. However, when the number of the cyano functional groups in the nitrile compound is greater than 3, the improvement in the adsorption effect resulted from the increase in the number of functional groups will become very weak. Therefore, preferably, in some examples of the present application, the nitrile compound containing 2 or 3 cyano groups is added. Therefore, in some examples of the present application, by applying a combination of nitrile compound, fluorophosphazene, fluoroether as into the electrolyte, the safety performance of lithium-ion battery may be further improved through the synergistic effect of above three.

In electrolyte of some examples of the present application, the nitrile compound is one or more selected from a group of the compounds represented by formula 1, formula 2 and formula 3. Among them, R₁₁ is one or more selected from a group of alkylene comprising 1 to 5 carbon atoms and alkyleneoxy comprising 1 to 5 carbon atoms; R₂₁ and R₂₂ are one or more each independently selected from a group of alkylene comprising 0 to 5 carbon atoms. R₃₁, R₃₂ and R₃₃ are one or more each independently selected from a group of alkylene comprising 0 to 5 carbon atoms and alkyleneoxy comprising 1 to 5 carbon atoms;

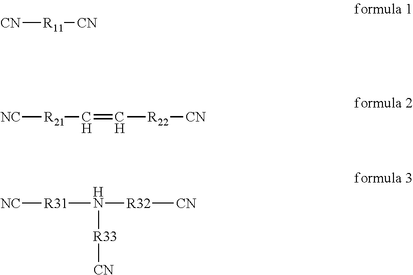

In electrolyte of some examples of the present application, specifically, the nitrile compound is one or more selected from a group of the following compounds;

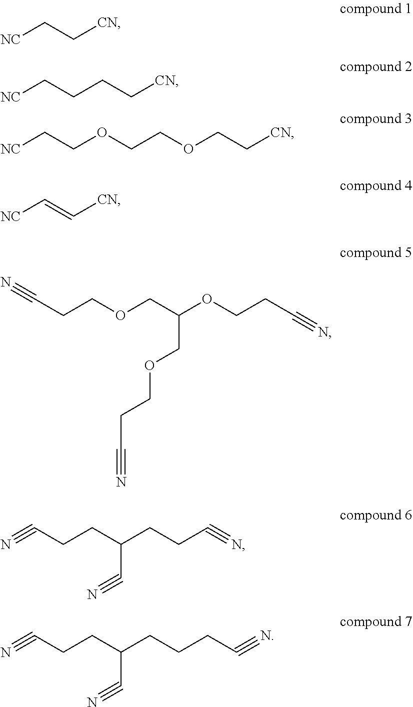

In electrolyte of some examples of the present application, fluorophosphazene is one or more selected from a group of the compounds represented by formula 4. wherein, R₄₁ is one selected from a group of alkyl comprising 1 to 6 carbon atoms, a phenyl, a halogenated alkyl, and a halogenated phenyl;

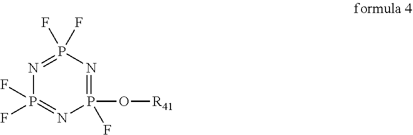

According to some embodiments of the present application, the fluorophosphazene is one or more selected from a group of 2,2,4,4,6-Pentafluoro-6-methoxy-2λ⁵,4λ⁵,6λ⁵-[1,3,5,2,4,6]triazatriph osphinine (CH₃OP₃N₃F₅), 2-Ethoxy-2,4,4,6,6-pentafluoro-2λ⁵,4λ⁵,6λ⁵-[1,3,5,2,4,6]triazatripho sphinin (C₂H₅OP₃N₃F₅), 2,2,4,4,6-Pentafluoro-6-propoxy-2λ⁵,4λ⁵,6λ⁵-[1,3,5,2,4,6]triazatriph osphinine (C₃H₇OP₃N₃F₅), 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), 2,2,4,4,6-Pentafluoro-6-phenoxy-2λ⁵,4λ⁵,6λ⁵-[1,3,5,2,4,6]triazatriph osphinine (C₆H₅OP₃N₃F₅), 2,2,4,4,6-Pentafluoro-6-(4-fluoro-phenoxy)-2λ⁵,4λ⁵,6λ⁵-[1,3,5,2,4,6]triazatriphosphinine (C₆H₄OP₃N₃F₆).

According to some embodiments of the present application, the fluoroether is one or more selected from a group of the compounds represented by formula 5. Among them, R₅₁ and R₅₂ are each independently selected from fluoroalkyl comprising 1 to 5 carbon atoms.

R₅₁—O—R₅₂ formula 5

According to some embodiments of the present application, the fluoroether is one or more selected from a group of tetrafluoroethyl trifluoroethyl ether (CF₂HCF₂OCH₂CF₃), tetrafluoroethyl tetrafluoropropyl ether (CF₂HCF₂OCH₂CF₂CF₂H), tetrafluoroethyl hexafluorobutyl ether (CF₂HCF₂OCH₂CF₂CF₂—CF₂H), tetrafluoroethyl octafluoropentyl ether (CF₂HCF₂OCH₂—CF₂CF₂CF₂CF₂H).

According to some embodiments of the present application, the mass of the nitrile compound is 0.5% to 15% of the total mass of the electrolyte. When the mass percentage of nitrile compound is less than 0.5%, the adsorption on the surface of the positive electrode is insufficient, and the improvement in thermal stability is not significant; when the mass percentage of nitrile compound is higher than 15%, the viscosity and electrical conductivity of the electrolyte are adversely affected, thereby deteriorating the cycle performance of the lithium-ion battery.

According to some embodiments of the present application, the mass of the fluorophosphazene is 1% to 20% of the total mass of the electrolyte. When the mass percentage of fluorophosphazene is less than 1%, the improvement in the safety performance of the lithium-ion battery is not significant; when the mass percentage of fluorophosphazene is higher than 20%, the cycle performance of the lithium-ion battery may be deteriorated, possibly because when the amount of fluorophosphazene added is large, the viscosity of the electrolyte increases.

According to some embodiments of the present application, the mass of the fluoroether is 2% to 20% of the total mass of the electrolyte. When the mass percentage of fluoroether is less than 2%, the improvement in the safety performance of the lithium-ion battery is not significant; when the mass percentage of fluoroether is higher than 20%, the cycle performance of the lithium-ion battery may be deteriorated, possibly because when the amount of fluoroether is added in a large amount, the viscosity of the electrolyte it seriously affected, thus affecting the kinetics of the electrolyte, and thereby deteriorating the cycle.

In electrolyte of some examples of the present application, the specific kind of the organic solvent is not limited and the organic solvent may comprise one or more selected from a group of vinyl carbonate, propylene carbonate, butylene carbonate, ethyl methyl carbonate, dimethyl carbonate, diethyl carbonate, dipropyl carbonate, methyl propyl carbonate, ethyl propyl carbonate, 1,4-butyrolactone, methyl propionate, methyl butyrate, ethyl acetate, ethyl propionate, ethyl butyrate.

According to some embodiments of the present application, the lithium salt is one or more selected from a group of inorganic lithium salt and organic lithium salt; preferably, the lithium salt is one or more selected from a group of lithium hexafluorophosphate (LiPF₆), lithium difluorophosphate (LiPO₂F₂), lithium tetrafluoroborate (LiBF₄), lithium hexafluoroarsenate, lithium perchlorate, lithium dioxalate borate (LiBOB), lithium difluoro(oxalato) borate (LiDFOB), lithium bis(fluorosulfonyl)imide (LiFSI), bistrifluoromethanesulfonimide lithium salt (LiTFSI); further preferably, the lithium salt is selected from lithium hexafluorophosphate (LiPF₆).

According to some embodiments of the present application, the concentration of the lithium salt is 0.5 mol/L to 1.5 mol/L, and preferably, the concentration of the lithium salt is 0.8 mol/L to 1.2 mol/L.

According to some embodiments of the present application, the additive further comprises one or more selected from a group of cyclic carbonate with carbon-carbon double bond and fluorinated cyclic carbonate. By adding cyclic carbonate with carbon-carbon double bond or fluorinated cyclic carbonate, the cycle performance of a lithium-ion battery may be remarkably improved.

According to some embodiments of the present application, the mass of the cyclic carbonate with carbon-carbon double bond is 0.1% to 10% of the total mass of the electrolyte and the mass of the fluorinated cyclic carbonate is 0.1% to 20% of the total mass of the electrolyte.

In electrolyte of some examples of the present application, cyclic carbonate with carbon-carbon double bond is one or more selected from a group of vinylene carbonate (VC), 4-methylvinylene carbonate, and 4-ethylvinylene carbonate, and fluorinated cyclic carbonate is one or more selected from a group of fluoroethylene carbonate (FEC), difluoroethylene carbonate, trifluoromethyl ethylene carbonate.

According to some embodiments of the present application, the electrolyte may be prepared by a conventional method, for example, by mixing the constituent materials of the electrolyte uniformly.

According to still other examples of the present application, the lithium-ion battery is provided comprising above-mentioned electrolyte and further comprising a positive electrode containing a positive electrode active material, a negative electrode containing a negative electrode active material and a separator. The specific types of the positive electrode active materials are not particularly limited and may be selected according to requirements. Specifically, the positive electrode active material is one or more selected from a group of lithium cobalt oxide (LiCoO₂), lithium nickel manganese cobalt ternary material, lithium iron phosphate (LiFePO₄), and lithium manganate (LiMn₂O₄). The specific types of the negative electrode active materials are not particularly limited and may be selected according to requirements. Specifically, the negative electrode active material is one or more selected from a group of natural graphite, artificial graphite, mesophase micro carbon sphere (referred to as MCMB), hard carbon, soft carbon, silicon, silicon-carbon composites, Li—Sn alloy, Li—Sn—O alloy, Sn, SnO, SnO₂, lithium TiO₂—Li₄Ti₅O₁₂ with spinel structure, Li—Al alloy.

The preparation of a lithium-ion battery is described below. The preparation method comprises: preparation of a positive electrode, a negative electrode, an electrolyte, a separator, and preparation of a lithium-ion battery, specifically comprising the following steps:

Preparation of a positive electrode: a positive electrode active material such as lithium cobalt oxide (LiCoO₂), lithium nickel manganese cobalt ternary material, lithium iron phosphate (LiFePO₄), lithium manganate (LiMn₂O₄), preferably lithium cobalt oxide (LiCoO₂), a conductive agent of Super P, a binder of polyvinylidene fluoride are mixed at a weight ratio of 90˜98:1˜2:1˜3, preferably 97:1.4:1.6, then N-methylpyrrolidone (NMP) is added for stirring under a vacuum mixer until the system is uniformly transparent to obtain a positive slurry, wherein the solid content of the positive slurry is 70 wt %˜80 wt %, preferably the solid content is 72 wt %; the positive slurry is uniformly coated on the positive current collector of aluminum foil; the aluminum foil is dried at 80˜90° C., preferably 85° C., and then subjected to pressing, cutting, and slitting, and then dried under vacuum at 80˜90° C., preferably 85° C. for 2-6 hours, preferably 4 hours, to obtain a positive electrode.

Preparation of a negative electrode: a negative electrode active material such as natural graphite, artificial graphite, mesophase micro carbon sphere(referred to as MCMB), hard carbon, soft carbon, silicon, silicon-carbon composites, Li—Sn alloy, Li—Sn—O alloy, Sn, SnO, SnO₂, lithium TiO₂—Li₄Ti₅O₁₂ with spinel structure, Li—Al alloy, preferably a negative electrode active material of artifical graphite, a conductive agent of Super P, a thickener of sodium carboxymethyl cellulose (CMC), a binder of styrene-butadiene rubber (SBR) are mixed at a weight ratio of 90˜98:1˜2:0.1˜1:1˜2, preferably 96.4:1.5:0.5:1.6, then a deionized water is added for stirring under a vacuum mixer to obtain a negative slurry, wherein the solid content of the negative slurry is 50 wt %˜60 wt %, preferably the solid content is 54 wt %; the negative slurry is uniformly coated on the negative current collector of copper foil; the copper foil is dried at 80˜90° C., preferably 85° C., and then subjected to pressing, cutting, and slitting, and then dried under vacuum at 110˜130° C., preferably 120° C. for 10-14 hours, preferably 12 hours, to obtain a negative electrode.

Preparation of electrolyte: in a glove box with dry argon atmosphere, ethylene carbonate (EC), ethyl methyl carbonate (EMC), and diethyl carbonate (DEC) are mixed in a mass ratio of EC:EMC:DEC is 20˜40:40˜60:10˜30, preferably 30:50:20, then an additive is added for dissolving and stirring well, and then a lithium salt of LiPF₆ is added for uniformly mixing to obtain an electrolyte. Among them, the concentration of LiPF₆ is 0.5 mol/L˜1.5 mol/L, preferably 1.05 mol/L. The additive comprises cyclic carbonate with carbon-carbon double bond, fluorocyclic carbonate, nitrile compound, fluorophosphazene, fluoroether described above. Among them, the mass percentage of nitrile compound in the electrolyte is 0.5% to 15%, the mass percentage of fluorophosphazene in the electrolyte is 1% to 20%, the mass percentage of fluoroether in the electrolyte is 2% to 20%, the mass percentage of cyclic carbonate with carbon-carbon double bond in the electrolyte is 0.1% to 10% and the mass percentage of fluorinated cyclic carbonate in the electrolyte is 0.1% to 20%.

Preparation of a separator: a polyethylene (PE) separator with a thickness of 5 to 20 μm, preferably 9 μm, is used.

Preparation of lithium-ion battery: the positive electrode, the separator and the negative electrode are stacked in order so that the separator can separate the positive electrode from the negative electrode, and then are wound to obtain a bare battery; the bare battery is placed in an outer packaging shell with aluminum plastic film after an electrode tab is welded, and the prepared electrolyte solution is injected into the dried bare battery, and then subjected to processes such as vacuum sealing, stewing, forming (charging to 3.3V with a constant current of 0.02 C, and then charging to 3.6V with a constant current of 0.1 C), shaping and capacity testing, to obtain a soft pack lithium-ion battery.

Those skilled person in the art will appreciate that the above described methods for preparing the lithium battery are merely examples. Other methods, materials, value ranges commonly used in the art may be employed without departing from the disclosure of the present application.

Some specific examples and comparative examples are listed below to better illustrate the application.

### EXAMPLE 1

Preparation of a positive electrode: a positive electrode active material of lithium cobalt oxide (LiCoO₂), a conductive agent of Super P, a binder of polyvinylidene fluoride are mixed at a weight ratio of 97:1.4:1.6, then N-methylpyrrolidone (NMP) is added for stirring under a vacuum mixer until the system is uniformly transparent to obtain a positive slurry, wherein the solid content of the positive slurry is 72 wt %; the positive slurry is uniformly coated on the positive current collector of aluminum foil; the aluminum foil is dried at 85° C., and then subjected to cold pressing, cutting, and slitting, and then dried under vacuum at 85° C. for 4 hours, to obtain a positive electrode.

Preparation of a negative electrode: a positive electrode active material of artificial graphite, a conductive agent of Super P, a thickener of sodium carboxymethyl cellulose (CMC), a binder of styrene-butadiene rubber (SBR) are mixed at a weight ratio of 96.4:1.5:0.5:1.6, then a deionized water is added for stirring under a vacuum mixer to obtain a negative slurry, wherein the solid content of the negative slurry is 54 wt %; the negative slurry is uniformly coated on the negative current collector of copper foil; the copper foil is dried at 85° C., and then subjected to cold pressing, cutting, and slitting, and then dried under vacuum at 120° C. for 12 hours, to obtain a negative electrode.

Preparation of electrolyte: in a glove box with dry argon atmosphere, ethylene carbonate (EC), ethyl methyl carbonate (EMC), and diethyl carbonate (DEC) are mixed in a mass ratio of EC:EMC:DEC being 30:50:20, then an additive is added for dissolving and stirring well, and then a lithium salt of LiPF₆ is added for uniformly mixing to obtain an electrolyte. Among them, the concentration of LiPF₆ is 1.05 mol/L. The additive used in the electrolyte comprises 0.5 wt % of vinylene carbonate (VC) and 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

Preparation of separator: a polyethylene (PE) separator with a thickness of 9 μm is used.

Preparation of lithium-ion battery: the positive electrode, the separator and the negative electrode are stacked in order so that the separator can separate the positive electrode from the negative electrode, and then are wound to obtain a bare battery; the bare battery is placed in a outer packaging shell with aluminum plastic film after an electrode pole is welded, and the prepared electrolyte solution is injected into the dried bare battery, and then subjected to processes such as vacuum sealing, stewing, forming (charging to 3.3V with a constant current of 0.02 C, and then charging to 3.6V with a constant current of 0.1 C), shaping and capacity testing, to obtain a soft pack lithium-ion battery.

### EXAMPLE 2

The preparation method is the same as that of Example 1, except that the additive used in the electrolyte of Example 2 comprises 0.5 wt % of vinylene carbonate (VC), 2 wt % of fluoroethylene carbonate (FEC), 3 wt % of the above compound 1, 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈) and 5 wt % of tetrafluoroethyl tetrafluoro-propyl ether (CF₂HCF₂OCH₂CF₂CF₂H), respectively, based on the total mass of the electrolyte.

### EXAMPLE 3

The preparation method is the same as that of Example 1, except that the additive used in the electrolyte of Example 3 comprises 0.5 wt % of vinylene carbonate (VC), 2 wt % of fluoroethylene carbonate (FEC), 3 wt % of the above compound 4, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₅OCH₂CF₂CF₂H), respectively, based on the total mass of the electrolyte.

### EXAMPLE 4

The preparation method is the same as that of Example 1, except that the additive used in the electrolyte of Example 4 comprises 0.5 wt % of vinylene carbonate (VC), 2 wt % of fluoroethylene carbonate (FEC), 3 wt % of the above compound 4, 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈) and 5 wt % of tetrafluoroethyl tetrafluoropropyl ether (CF₂HCF₂OCH₂CF₂CF₂H), respectively, based on the total mass of the electrolyte.

### EXAMPLE 5

The preparation method is the same as that of Example 1, except that the additive used in the electrolyte of Example 5 comprises 0.5 wt % of vinylene carbonate (VC), 2 wt % of fluoroethylene carbonate (FEC), 3 wt % of the above compound 6, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 6

The preparation method is the same as that of Example 1, except that the additive used in the electrolyte of Example 6 comprises 0.5 wt % of vinylene carbonate (VC), 2 wt % of fluoroethylene carbonate (FEC), 3 wt % of the above compound 6, 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈) and 5 wt % of tetrafluoroethyl tetrafluoropropyl ether (CF₂HCF₂OCH₂CF₂CF₂H), respectively, based on the total mass of the electrolyte.

### EXAMPLE 7

The preparation method is the same as that of Example 1, except that the additive used in the electrolyte of Example 7 comprises 0.5 wt % of vinylene carbonate (VC), 2 wt % of fluoroethylene carbonate (FEC), 6 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 8

The preparation method is the same as that of Example 1, except that the additive used in the electrolyte of Example 8 comprises 0.5 wt % of vinylene carbonate (VC), 2 wt % of fluoroethylene carbonate (FEC), 9 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 9

The preparation method is the same as that of Example 1, except that the additive used in the electrolyte of Example 9 comprises 0.5 wt % of vinylene carbonate (VC) and 2 wt % of fluoroethylene carbonate (FEC), 12 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5% wt % of tetrafluoroethyl tetrafluoropropyl ether (CF₂HCF₂OCH₂CF₂CF₂H), respectively, based on the total mass of the electrolyte.

### EXAMPLE 10

The preparation method is the same as that of Example 1, except that the additive used in the electrolyte of Example 10 comprises 0.5 wt % of vinylene carbonate (VC), 2 wt % of fluoroethylene carbonate (FEC), 15 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 11

The preparation method is the same as that of Example 1, except that the additive used in the electrolyte of Example 11 comprises 0.5 wt % of vinylene carbonate (VC), 2 wt % of fluoroethylene carbonate (FEC), 3 wt % of the above compound 1, 10 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 12

The preparation method is the same as that of Example 1, except that the additive used in the electrolyte of Example 12 comprises 0.5 wt % of vinylene carbonate (VC), 2 wt % of fluoroethylene carbonate (FEC), 3 wt % of the above compound 1, 15 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 13

The preparation method is the same as that of Example 1, except that the additive used in the electrolyte of Example 13 comprises 0.5 wt % of vinylene carbonate (VC), 2 wt % of fluoroethylene carbonate (FEC), 3 wt % of the above compound 1, 20 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 14

The preparation method is the same as that of Example 1, except that the additive used in the electrolyte of Example 14 comprises 0.5 wt % of vinylene carbonate (VC), 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin(C₂H₅OP₃N₃F₅) and 10 wt % of tetrafluoroethyl tetrafluoropropyl ether (CF₂HCF₂OCH₂CF₂CF₂H), respectively, based on the total mass of the electrolyte.

### EXAMPLE 15

The preparation method is the same as that of Example 1, except that the additive used in the electrolyte of Example 15 comprises 0.5 wt % of vinylene carbonate (VC), 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 15 wt % of tetrafluoroethyl tetrafluoropropyl ether (CF₂HCF₂OCH₂CF₂CF₂H), respectively, based on the total mass of the electrolyte.

### EXAMPLE 16

The preparation method is the same as that of Example 1, except that the additive used in the electrolyte of Example 16 comprises 0.5 wt % of vinylene carbonate (VC), 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin(C₂H₅OP₃N₃F₅) and 20 wt % of tetrafluoroethyl tetrafluoropropyl ether (CF₂HCF₂OCH₂CF₂CF₂H), respectively, based on the total mass of the electrolyte.

### EXAMPLE 17

The preparation method is the same as that of Example 1, except that the additive used in the electrolyte of Example 17 comprises 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte, but does not comprise vinylene carbonate (VC) and fluoroethylene carbonate (FEC).

### EXAMPLE 18

The preparation method is the same as that of Example 1, except that the additive used in the electrolyte of Example 18 comprises 0.5 wt % of vinylene carbonate (VC), 2 wt % of fluoroethylene carbonate (FEC), 0.5 wt % of the above compound 1, 5 wt % of 2-Ethoxy-2,4,4,6,6-pentafluoro-2λ⁵,4λ⁵,6λ⁵-[1,3,5,2,4,6]triazatripho sphinin(C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 19

The preparation method is the same as that of Example 1, except that the additive used in the electrolyte of Example 19 comprises 0.5 wt % of vinylene carbonate (VC), 2 wt % of fluoroethylene carbonate (FEC), 3 wt % of the above compound 1, 1 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₂OCH₂CF₂CF₂H), respectively, based on the total mass of the electrolyte.

### EXAMPLE 20

The preparation method is the same as that of Example 1, except that the additive used in the electrolyte of Example 20 comprises 0.5 wt % of vinylene carbonate (VC), 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin(C₂H₅OP₃N₃F₅) and 2 wt % of tetrafluoroethyl tetrafluoropropyl ether (CF₂HCF₂OCH₂CF₂CF₂H), respectively, based on the total mass of the electrolyte.

### COMPARATIVE EXAMPLE 1

The preparation method is the same as that of Example 1, except that the additive used in the electrolyte of Comparative Example 1 only comprises 0.5 wt % of vinylene carbonate (VC) and 2 wt % of fluoroethylene carbonate (FEC), respectively, based on the total mass of the electrolyte, but does not comprise the nitrile compound, fluorophosphazene and fluoroether.

### COMPARATIVE EXAMPLE 2

The preparation method is the same as that of Example 1, except that the additive used in the electrolyte of Comparative Example 2 comprises 0.5 wt % of vinylene carbonate (VC), 2 wt % of fluoroethylene carbonate (FEC) and 3 wt % of above compound 1, respectively, based on the total mass of the electrolyte, but does not comprise fluorophosphazene and fluoroether.

### COMPARATIVE EXAMPLE 3

The preparation method is the same as that of Example 1, except that the additive used in the electrolyte of Comparative Example 3 comprises 0.5 wt % of vinylene carbonate (VC), 2 wt % of fluoroethylene carbonate (FEC) and 3 wt % of above compound 4, respectively, based on the total mass of the electrolyte, but does not comprise fluorophosphazene and fluoroether.

### COMPARATIVE EXAMPLE 4

The preparation method is the same as that of Example 1, except that the additive used in the electrolyte of Comparative Example 4 comprises 0.5 wt % of vinylene carbonate (VC), 2 wt % of fluoroethylene carbonate (FEC) and 3 wt % of above compound 6, respectively, based on the total mass of the electrolyte, but does not comprise fluorophosphazene and fluoroether.

### COMPARATIVE EXAMPLE 5

The preparation method is the same as that of Example 1, except that the additive used in the electrolyte of Comparative Example 5 comprises 0.5 wt % of vinylene carbonate (VC), 2 wt % of fluoroethylene carbonate (FEC) and 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅), respectively, based on the total mass of the electrolyte, but does not comprise the nitrile compound and fluoroether.

### COMPARATIVE EXAMPLE 6

The preparation method is the same as that of Example 1, except that the additive used in the electrolyte of Comparative Example 6 comprises 0.5 wt % of vinylene carbonate (VC), 2 wt % of fluoroethylene carbonate (FEC) and 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), respectively, based on the total mass of the electrolyte, but does not comprise the nitrile compound and fluoroether.

### COMPARATIVE EXAMPLE 7

The preparation method is the same as that of Example 1, except that the additive used in the electrolyte of Comparative Example 7 comprises 0.5 wt % of vinylene carbonate (VC), 2 wt % of fluoroethylene carbonate (FEC) and 5 wt % of tetrafluoroethyl tetrafluoropropyl ether (CF₂HCF₂OCH₂CF₂CF₂H), respectively, based on the total mass of the electrolyte, but does not comprise the nitrile compound and fluorophosphazene.

### COMPARATIVE EXAMPLE 8

The preparation method is the same as that of Example 1, except that the additive used in the electrolyte of Comparative Example 8 comprises 0.5 wt % of vinylene carbonate (VC), 2 wt % of fluoroethylene carbonate (FEC), 3 wt % of above compound 1 and 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅), respectively, based on the total mass of the electrolyte, but does not comprise fluoroether.

### COMPARATIVE EXAMPLE 9

The preparation method is the same as that of Example 1, except that the additive used in the electrolyte of Comparative Example 9 comprises 0.5 wt % of vinylene carbonate (VC), 2 wt % of fluoroethylene carbonate (FEC), 3 wt % of above compound 1 and 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), respectively, based on the total mass of the electrolyte, but does not comprise fluoroether.

### COMPARATIVE EXAMPLE 10

The preparation method is the same as that of Example 1, except that the additive used in the electrolyte of Comparative Example 10 comprises 0.5 wt % of vinylene carbonate (VC), 2 wt % of fluoroethylene carbonate (FEC), 3 wt % of above compound 1 and 5 wt % of tetrafluoroethyl tetrafluoropropyl ether (CF₂HCF₂OCH₂CF₂CF₂H), respectively, based on the total mass of the electrolyte, but does not comprise fluorophosphazene.

### COMPARATIVE EXAMPLE 11

The preparation method is the same as that of Example 1, except that the additive used in the electrolyte of Comparative Example 11 comprises 0.5 wt % of vinylene carbonate (VC), 2 wt % of fluoroethylene carbonate (FEC), 3 wt % of above compound 4 and 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅), respectively, based on the total mass of the electrolyte, but does not comprise fluoroether.

### COMPARATIVE EXAMPLE 12

The preparation method is the same as that of Example 1, except that the additive used in the electrolyte of Comparative Example 12 comprises 0.5 wt % of vinylene carbonate (VC), 2 wt % of fluoroethylene carbonate (FEC), 3 wt % of above compound 4 and 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), respectively, based on the total mass of the electrolyte, but does not comprise fluoroether.

### COMPARATIVE EXAMPLE 13

The preparation method is the same as that of Example 1, except that the additive used in the electrolyte of Comparative Example 13 comprises 0.5 wt % of vinylene carbonate (VC), 2 wt % of fluoroethylene carbonate (FEC), 3 wt % of above compound 4 and 5 wt % of tetrafluoroethyl tetrafluoropropyl ether (CF₂HCF₂OCH₂CF₂CF₂H), respectively, based on the total mass of the electrolyte, but does not comprise fluorophosphazene.

### COMPARATIVE EXAMPLE 14

The preparation method is the same as that of Example 1, except that the additive used in the electrolyte of Comparative Example 14 comprises 0.5 wt % of vinylene carbonate (VC), 2 wt % of fluoroethylene carbonate (FEC), 3 wt % of above compound 6 and 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅), respectively, based on the total mass of the electrolyte, but does not comprise fluoroether.

### COMPARATIVE EXAMPLE 15

The preparation method is the same as that of Example 1, except that the additive used in the electrolyte of Comparative Example 15 comprises 0.5 wt % of vinylene carbonate (VC), 2 wt % of fluoroethylene carbonate (FEC), 3 wt % of above compound 6 and 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), respectively, based on the total mass of the electrolyte, but does not comprise fluoroether.

### COMPARATIVE EXAMPLE 16

The preparation method is the same as that of Example 1, except that the additive used in the electrolyte of Comparative Example 16 comprises 0.5 wt % of vinylene carbonate (VC) and 2 wt % of fluoroethylene carbonate (FEC), 3 wt % of the above compound 6 and 5 wt % of tetrafluoroethyl tetrafluoropropyl ether (CF₂HCF₂OCH₂CF₂CF₂H), respectively, based on the total mass of the electrolyte, but does not comprise fluorophosphazene.

### COMPARATIVE EXAMPLE 17

The preparation method is the same as that of Example 1, except that the additive used in the electrolyte of Comparative Example 17 comprises 0.5 wt % of vinylene carbonate (VC), 2 wt % of fluoroethylene carbonate (FEC), 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₅OCH₂CF₂CF₂H), respectively, based on the total mass of the electrolyte, but does not comprise the nitrile compound.

### COMPARATIVE EXAMPLE 18

The preparation method is the same as that of Example 1, except that the additive used in the electrolyte of Comparative Example 18 comprises 0.5 wt % of vinylene carbonate (VC), 2 wt % of fluoroethylene carbonate (FEC), 5 wt % of 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈) and 5 wt % of tetrafluoroethyl tetrafluoropropyl ether (CF₂HCF₅OCH₂CF₂CF₂H), respectively, based on the total mass of the electrolyte, but does not comprise the nitrile compound.

### COMPARATIVE EXAMPLE 19

The preparation method is the same as that of Example 1, except that the additive used in the electrolyte of Comparative Example 19 comprises 0.5 wt % of vinylene carbonate (VC), 2 wt % of fluoroethylene carbonate (FEC), 18 wt % of the above compound 1, 5 wt % of 2-Ethoxy-2,4,4,6,6-pentafluoro-2λ⁵,4λ⁵,6λ⁵-[1,3,5,2,4,6]triazatripho sphinin(C₂H₅OP₃N₃F₅) and 5 wt % of tetrafluoroethyl tetrafluoropropyl ether (CF₂HCF₅OCH₂CF₂CF₂H), respectively, based on the total mass of the electrolyte.

### COMPARATIVE EXAMPLE 20

The preparation method is the same as that of Example 1, except that the additive used in the electrolyte of Comparative Example 20 comprises 0.5 wt % of vinylene carbonate (VC), 2 wt % of fluoroethylene carbonate (FEC), 3 wt % of the above compound 1, 25 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 5 wt % of tetrafluoroethyl tetrafluoropropyl ether (CF₂HCF₅OCH₂CF₂CF₂H), respectively, based on the total mass of the electrolyte.

### COMPARATIVE EXAMPLE 21

The preparation method is the same as that of Example 1, except that the additive used in the electrolyte of Comparative Example 21 comprises 0.5 wt % of vinylene carbonate (VC), 2 wt % of fluoroethylene carbonate (FEC), 3 wt % of the above compound 1, 5 wt % of 2-Ethoxy-2,4,4,6,6-pentafluoro-2λ⁵,4λ⁵,6λ⁵-[1,3,5,2,4,6]triazatripho sphinin (C₂H₅OP₃N₃F₅) and 25 wt % of tetrafluoroethyl tetrafluoropropyl ether (CF₂HCF₅OCH₂CF₂CF₂H), respectively, based on the total mass of the electrolyte.

The specific types and contents of the additives used in the electrolytes of the respective Examples and Comparative Examples described above are shown in Table 1. In Table 1, the content of the additive is a mass percentage calculated based on the total mass of the electrolyte.

TABLE 1

| | | | nitrile compound | | | fluorophosphazene | | fluoroether |
|---|---|---|---|---|---|---|---|---|
| | VC | FEC | compound 1 | compound 4 | compound 6 | C₂H₅OP₃N₃F₅ | C₂H₂OP₃N₃F₈ | CF₂HCF₂OCH2CF₂CF₂H |
| | (%) | (%) | (%) | (%) | (%) | (%) | (%) | (%) |
| Example 1 | 0.5 | 2 | 3 | | | 5 | | 5 |
| Example 2 | 0.5 | 2 | 3 | | | | 5 | 5 |
| Example 3 | 0.5 | 2 | | 3 | | 5 | | 5 |
| Example 4 | 0.5 | 2 | | 3 | | | 5 | 5 |
| Example 5 | 0.5 | 2 | | | 3 | 5 | | 5 |
| Example 6 | 0.5 | 2 | | | 3 | | 5 | 5 |
| Example 7 | 0.5 | 2 | 6 | | | 5 | | 5 |
| Example 8 | 0.5 | 2 | 9 | | | 5 | | 5 |
| Example 9 | 0.5 | 2 | 12 | | | 5 | | 5 |
| Example 10 | 0.5 | 2 | 15 | | | 5 | | 5 |
| Example 11 | 0.5 | 2 | 3 | | | 10 | | 5 |
| Example 12 | 0.5 | 2 | 3 | | | 15 | | 5 |
| Example 13 | 0.5 | 2 | 3 | | | 20 | | 5 |
| Example 14 | 0.5 | 2 | 3 | | | 5 | | 10 |
| Example 15 | 0.5 | 2 | 3 | | | 5 | | 15 |
| Example 16 | 0.5 | 2 | 3 | | | 5 | | 20 |
| Example 17 | | | 3 | | | 5 | | 5 |
| Example 18 | 0.5 | 2 | 0.5 | | | 5 | | 5 |
| Example 19 | 0.5 | 2 | 3 | | | 1 | | 5 |
| Example 20 | 0.5 | 2 | 3 | | | 5 | | 2 |
| Comparative | 0.5 | 2 | | | | | | |
| Example 1 | | | | | | | | |
| Comparative | 0.5 | 2 | 3 | | | | | |
| Example 2 | | | | | | | | |
| Comparative | 0.5 | 2 | | 3 | | | | |
| Example 3 | | | | | | | | |
| Comparative | 0.5 | 2 | | | 3 | | | |
| Example 4 | | | | | | | | |
| Comparative | 0.5 | 2 | | | | 5 | | |
| Example 5 | | | | | | | | |
| Comparative | 0.5 | 2 | | | | | 5 | |
| Example 6 | | | | | | | | |
| Comparative | 0.5 | 2 | | | | | | 5 |
| Example 7 | | | | | | | | |
| Comparative | 0.5 | 2 | 3 | | | 5 | | |
| Example 8 | | | | | | | | |
| Comparative | 0.5 | 2 | 3 | | | | 5 | |
| Example 9 | | | | | | | | |
| Comparative | 0.5 | 2 | 3 | | | | | 5 |
| Example 10 | | | | | | | | |
| Comparative | 0.5 | 2 | | 3 | | 5 | | |
| Example 11 | | | | | | | | |
| Comparative | 0.5 | 2 | | 3 | | | 5 | |
| Example 12 | | | | | | | | |
| Comparative | 0.5 | 2 | | 3 | | | | 5 |
| Example 13 | | | | | | | | |
| Comparative | 0.5 | 2 | | | 3 | 5 | | |
| Example 14 | | | | | | | | |
| Comparative | 0.5 | 2 | | | 3 | | 5 | |
| Example 15 | | | | | | | | |
| Comparative | 0.5 | 2 | | | 3 | | | 5 |
| Example 16 | | | | | | | | |
| Comparative | 0.5 | 2 | | | | 5 | | 5 |
| Example 17 | | | | | | | | |
| Comparative | 0.5 | 2 | | | | | 5 | 5 |
| Example 18 | | | | | | | | |
| Comparative | 0.5 | 2 | 18 | | | 5 | | 5 |
| Example 19 | | | | | | | | |
| Comparative | 0.5 | 2 | 3 | | | 25 | | 5 |
| Example 20 | | | | | | | | |
| Comparative | 0.5 | 2 | 3 | | | 5 | | 25 |
| Example 21 | | | | | | | | |

Next, the test process of the lithium-ion battery will be described.

The test method is as follows:

Test for cycle performance of lithium-ion battery: the lithium-ion battery is placed in a 25° C. incubator and allowed to stand for 30 minutes to keep the lithium-ion battery at a constant temperature. The lithium-ion battery with a constant temperature is charged at a constant current of 0.7 C to a voltage of 4.3V, then charged at a constant voltage of 4.3V to a current of 0.05 C, and then discharged at a constant current of 1 C to a voltage of 3.0 V. The process described above is a charge and discharge cycle. The capacity of the initial discharge is determined as 100%, the charge and discharge cycle is repeated until the discharge capacity is attenuated to 80%, then the test is stopped, and the number of cycles is recorded as an index for evaluating the cycle performance of the lithium-ion battery.

Test for hot-tank storage performance of lithium-ion battery: the lithium-ion battery is placed in a 25° C. hot tank and allowed to stand for 30 minutes to keep the lithium-ion battery at a constant temperature. The lithium-ion battery with a constant temperature is charged at a constant current of 0.5 C to a voltage of 4.3V, and then charged at a constant voltage of 4.3V to a current of 0.025 C. After standing for 1 hour, the hot tank is heated to 150° C. at a heating rate of 5° C./min, and kept at a constant temperature for 120 min, and the ignition failure time of the battery is recorded as an index for evaluating the safety performance of the lithium-ion battery.

Test for nail performance of lithium-ion battery: the lithium-ion battery is placed in a 25° C. incubator and allowed to stand for 30 minutes to keep the lithium-ion battery at a constant temperature. The lithium-ion battery with a constant temperature is charged at a constant current of 0.5 C to a voltage of 4.3V, and then charged at a constant voltage of 4.3V to a current of 0.025 C. The fully-charged battery is transferred to the nail tester while keeping the test environment temperature at 25° C.±2° C., and then a steel nail with a diameter of 4 mm is used to pass through the center of the battery at a constant speed of 30 mm/s. If the battery does not ignite, explode, it is defined as “Pass”. 20 pieces of battery are tested each time. The number of battery passing Nail test is used as an indicator for evaluating the safety performance of lithium-ion battery.

According to the test methods described above, the performance test is carried out on the lithium-ion batteries prepared in Examples 1-20 and Comparative Examples 1-21, respectively. The results of performance test are as follows:

TABLE 2

| | number | hot-box failure | number of |
|---|---|---|---|
| | of cycles | time at | pass for |
| | at 25° C. | 150° C. (min) | Nail test |
| Example 1 | 836 | 33 | 13 |
| Example 2 | 829 | 33 | 14 |
| Example 3 | 830 | 32 | 14 |
| Example 4 | 833 | 33 | 13 |
| Example 5 | 825 | 32 | 13 |
| Example 6 | 830 | 33 | 14 |
| Example 7 | 831 | 34 | 14 |
| Example 8 | 824 | 34 | 16 |
| Example 9 | 806 | 35 | 16 |
| Example 10 | 789 | 37 | 17 |
| Example 11 | 826 | 34 | 13 |
| Example 12 | 795 | 35 | 15 |
| Example 13 | 762 | 35 | 17 |
| Example 14 | 836 | 36 | 15 |
| Example 15 | 810 | 38 | 16 |
| Example 16 | 779 | 39 | 17 |
| Example 17 | 397 | 33 | 14 |
| Example 18 | 840 | 32 | 12 |
| Example 19 | 848 | 32 | 12 |
| Example 20 | 850 | 33 | 13 |
| Comparative | 865 | 27 | 2 |
| Example 1 | | | |
| Comparative | 851 | 29 | 5 |
| Example 2 | | | |
| Comparative | 856 | 29 | 5 |
| Example 3 | | | |
| Comparative | 862 | 30 | 7 |
| Example 4 | | | |
| Comparative | 849 | 28 | 4 |
| Example 5 | | | |
| Comparative | 852 | 29 | 5 |
| Example 6 | | | |
| Comparative | 879 | 29 | 5 |
| Example 7 | | | |
| Comparative | 850 | 30 | 9 |
| Example 8 | | | |
| Comparative | 852 | 30 | 10 |
| Example 9 | | | |
| Comparative | 870 | 31 | 10 |
| Example 10 | | | |
| Comparative | 847 | 30 | 8 |
| Example 11 | | | |
| Comparative | 852 | 30 | 9 |
| Example 12 | | | |
| Comparative | 863 | 31 | 10 |
| Example 13 | | | |
| Comparative | 848 | 30 | 9 |
| Example 14 | | | |
| Comparative | 855 | 30 | 10 |
| Example 15 | | | |
| Comparative | 861 | 31 | 10 |
| Example 16 | | | |
| Comparative | 840 | 29 | 9 |
| Example 17 | | | |
| Comparative | 845 | 29 | 10 |
| Example 18 | | | |
| Comparative | 690 | 40 | 18 |
| Example 19 | | | |
| Comparative | 540 | 37 | 19 |
| Example 20 | | | |
| Comparative | 502 | 41 | 19 |
| Example 21 | | | |

From the data analysis in Tables 1 and 2, and from Comparative Examples 1 and 2-7, it shows that the addition of a nitrile compound, a fluorophosphazene or a fluoroether alone may improve the safety of the lithium-ion battery while hardly deteriorating the cycle performance thereof. However, when they are used alone, the improvement effect on the safety of the lithium-ion battery is not obvious.

From Comparative Examples 2-7 and Comparative Examples 8-18, it shows that the addition of any two of nitrile compound, fluorophosphazene and fluoroether may further improve the safety performance of the lithium-ion battery comparing with the addition of any one thereof. However, the extent of the improvement is still limited.

In Examples 1-6, simultaneous addition of the nitrile compound, fluorophosphazene and fluoroether may continue to improve the safety performance of the lithium-ion battery comparing with the addition of any two thereof. At the same time, the cycle performance is hardly deteriorated.

From Examples 7-10, it shows that the increase in the content of nitrile compound may further improve the safety performance of the lithium-ion battery, but as the content of the nitrile compound increases, the cycle performance gradually deteriorates and the degree of deterioration is within an acceptable range. From Comparative Example 19 and Example 10, it shows that further increasing the content of nitrile compound on the basis that the content thereof is 15% may still improve the safety performance of the lithium-ion battery while seriously deteriorating the cycle performance of the lithium-ion battery.

From Examples 11-13, it shows that the increase in the content of the fluorophosphazene may further improve the safety performance of the lithium-ion battery, but as the content of the fluorophosphazene increases, the cycle performance gradually deteriorates and the degree of deterioration is within an acceptable range. From Comparative Example 20 and Example 13, it shows that further increasing the content of the fluorophosphazene on the basis that the content thereof is 20% may still improve the safety performance of the lithium-ion battery while seriously deteriorating the cycle performance of the lithium-ion battery.

From Examples 14-16, it shows that the increase in the content of the fluoroether may further improve the safety performance of the lithium-ion battery, but as the content of the fluoroether increases, the cycle performance gradually deteriorates and the degree of deterioration is within an acceptable range. From Comparative Example 21 and Example 16, it shows that further increasing the content of the fluoroether on the basis that the content thereof is 20% may still improve the safety performance of the lithium-ion battery while seriously deteriorating the cycle performance of the lithium-ion battery.

From Example 17, it shows that when VC and FEC are not contained, there is no significant influence on the safety performance of the lithium-ion battery, but the cycle performance of the lithium-ion battery is seriously deteriorated.

From Example 18, it shows that a more obvious improvement effect on safety performance can be achieved only if 0.5% of nitrile compound is added, on the basis of the appropriate amount of fluorophosphazene and fluoroether.

From Example 19, it shows that a more obvious improvement effect on safety performance can be achieved only if 1% of the fluorophosphazene is added, on the basis of the appropriate amount of nitrile compound and fluoroether.

From Example 20, it shows that obtain a more obvious improvement effect on safety performance can be achieved only if 2% of the fluoroether is added, on the basis of the appropriate amount of nitrile compound and fluorophosphazene.

Therefore, in some examples of the present application, by adding 0.1 wt %˜10 wt % of cyclic carbonate with carbon-carbon double bond and 0.1 wt %˜20 wt % of fluorinated cyclic carbonate, respectively, based on the total mass of the electrolyte, the cycle performance of lithium-ion battery may be improved; by simultaneously adding 0.5 wt %˜15 wt % of nitrile compound, 1 wt %˜20 wt % of fluorophosphazene and 2 wt %˜20 wt % of the fluoroether, based on the total mass of the electrolyte, and by applying a combination of these additives in the electrolyte, the thermal stability of the positive electrode material may be improved, the thermal runaway may be delayed, the flammability of the electrolyte may be reduced and the safety performance of the lithium-ion battery may be further improved through enhancing structural stability of the positive electrode surface of lithium-ion battery resulted from complex adsorption on the surface of the positive electrode, capturing free radicals in the primary chain reaction of thermal runaway, reducing the amount of free radicals and the intensity of chain reactions and increasing the flash point of the electrolyte.

Those skilled in the art will appreciate that the above-described examples are merely exemplary examples, and various changes, substitutions and changes may be made without departing from the spirit and scope of the present application.

What is claimed is:

1. An electrolyte, comprising an additive;
wherein the additive comprises nitrile compound, fluorophosphazene, and fluoroether.

2. The electrolyte according to claim 1, wherein nitrile compound is at least one selected from a group of compounds represented by formula 1, formula 2, and formula 3: 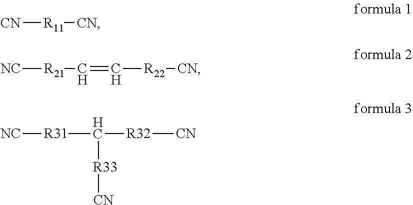
wherein R₁₁ is one selected from a group of alkylene comprising 1 to 5 carbon atoms and alkyleneoxy comprising 1 to 5 carbon atoms; R₂₁ and R₂₂ are one each independently selected from a group of alkylene comprising 0 to 5 carbon atoms; R₃₁, R₃₂ and R₃₃ are one each independently selected from a group of alkylene comprising 0 to 5 carbon atoms and alkyleneoxy comprising 1 to 5 carbon atoms.
the fluorophosphazene is one or more selected from a group of the compounds represented by formula 4: 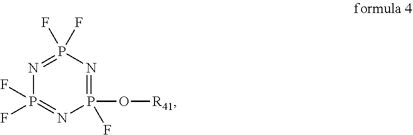
wherein R₄₁ is one selected from a group of alkyl comprising 1 to 6 carbon atoms, phenyl, halogenated alkyl, and halogenated phenyl;
the fluoroether is one or more selected from a group of the compounds represented by formula 5:
R₅₁—O—R₅₂ formula 5,
wherein R₅₁ and R₅₂ are each independently selected from one of fluoroalkyl comprising 1 to 5 carbon atoms.

3. The electrolyte according to claim 1, wherein nitrile compound is at least one selected from a group of following compounds:

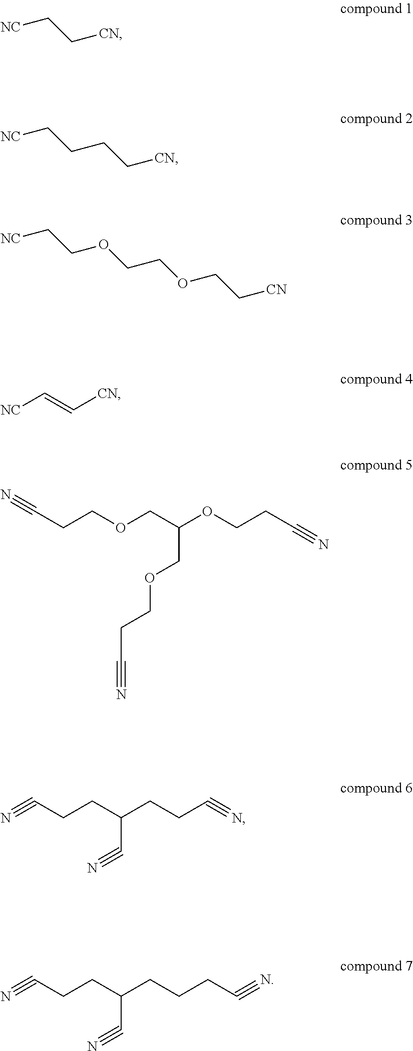

4. The electrolyte according to claim 1, wherein fluorophosphazene is one or more selected from a group of 2,2,4,4,6-Pentafluoro-6-methoxy-2λ⁵,4λ⁵,6λ⁵-[1,3,5,2,4,6]triazatriph osphinine (CH₃OP₃N₃F₅), 2-Ethoxy-2,4,4,6,6-pentafluoro-2λ⁵,4λ⁵,6λ⁵-[1,3,5,2,4,6]triazatripho sphinin (C₂H₅OP₃N₃F₅), 2,2,4,4,6-Pentafluoro-6-propoxy-2λ⁵,4λ⁵,6λ⁵-[1,3,5,2,4,6]triazatriph osphinine (C₃H₇OP₃N₃F₅), 2,2,4,4,6-Pentafluoro-6-(2,2,2-trifluoro-ethoxy)-2λ⁵,4λ⁵,6λ⁵-[1,3,5,2,4,6]triazatriphosphinine (C₂H₂OP₃N₃F₈), 2,2,4,4,6-Pentafluoro-6-phenoxy-2λ⁵,4λ⁵,6λ⁵-[1,3,5,2,4,6]triazatriph osphinine (C₆H₅OP₃N₃F₅), 2,2,4,4,6-Pentafluoro-6-(4-fluoro-phenoxy)-2λ⁵,4λ⁵,6λ⁵-[1,3,5,2,4,6]triazatriphosphinine (C₆H₄OP₃N₃F₆).

5. The electrolyte according to claim 1, wherein the fluoroether is one or more selected from a group of tetrafluoroethyl trifluoroethyl ether (CF₂HCF₂OCH₂CF₃), tetrafluoroethyl tetrafluoropropyl ether (CF₂HCF₂OCH₂CF₂CF₂H), tetrafluoroethyl hexafluorobutyl ether (CF₂HCF₂OCH₂CF₂CF₂CF₂H), tetrafluoroethyl octafluoropentyl ether (CF₂HCF₂OCH₂CF₂CF₂CF₂CF₂H).

6. The electrolyte according to claim 1, wherein the mass percentage of nitrile compound is 0.5% to 15% based on the total mass of the electrolyte, the mass percentage of fluorophosphazene is 1% to 20% based on the total mass of the electrolyte, and the mass percentage of fluoroether is 2% to 20% based on the total mass of the electrolyte.

7. The electrolyte according to claim 1, wherein the additive further comprises one or more selected from a group of cyclic carbonate with carbon-carbon double bond and fluorinated cyclic carbonate; the mass percentage of the cyclic carbonate with carbon-carbon double bond is 0.1% to 10% and the mass percentage of the fluorinated cyclic carbonate is 0.1% to 20%, based on the total mass of the electrolyte.

8. The electrolyte according to claim 7, wherein cyclic carbonate with carbon-carbon double bond is one or more selected from a group of vinylene carbonate (VC), 4-methylvinylene carbonate, and 4-ethylvinylene carbonate, and the fluorinated cyclic carbonate is one or more selected from a group of fluoroethylene carbonate (FEC), difluoroethylene carbonate, trifluoromethyl ethylene carbonate.

9. The electrolyte according to claim 1, wherein the electrolyte further comprises an organic solvent, and the organic solvent comprises one or more selected from a group of vinyl carbonate, propylene carbonate, butylene carbonate, ethyl methyl carbonate, dimethyl carbonate, diethyl carbonate, dipropyl carbonate, methyl propyl carbonate, ethyl propyl carbonate, 1,4-butyrolactone, methyl propionate, methyl butyrate, ethyl acetate, ethyl propionate, ethyl butyrate.

10. The electrolyte according to claim 1, wherein the electrolyte further comprises a lithium salt, and the lithium salt is one or more selected from a group of lithium hexafluorophosphate (LiPF₆), lithium difluorophosphate (LiPO₂F₂), lithium tetrafluoroborate (LiBF₄), lithium hexafluoroarsenate, lithium perchlorate, lithium dioxalate borate (LiBOB), lithium difluoro(oxalato) borate (LiDFOB), lithium bis(fluorosulfonyl)imide (LiFSI), bistrifluoromethanesulfonimide lithium salt (LiTFSI), wherein the concentration of the lithium salt is 0.5 mol/L to 1.5 mol/L.

11. The electrolyte according to claim 10, wherein the lithium salt is lithium hexafluorophosphate (LiPF₆), and the concentration of the lithium salt is 0.8 mol/L to 1.2 mol/L.

12. A lithium-ion battery, comprising the electrolyte according to claim 1.

13. The lithium-ion battery according to claim 12, wherein the lithium-ion battery further comprises a positive electrode containing a positive electrode active material, a negative electrode containing a negative electrode active material and a separator.

14. The lithium-ion battery according to claim 13, wherein the positive electrode active material is one or more selected from a group of lithium cobalt oxide (LiCoO₂), lithium nickel manganese cobalt ternary material, lithium iron phosphate (LiFePO₄), and lithium manganate (LiMn₂O₄), and the negative electrode active material is one or more selected from a group of natural graphite, artificial graphite, mesophase micro carbon sphere, hard carbon, soft carbon, silicon, silicon-carbon composites, Li—Sn alloy, Li—Sn—O alloy, Sn, SnO, SnO₂, lithium TiO₂—Li₄Ti₅O₁₂ with spinel structure, Li—Al alloy.
